(19) United States
(12) Patent Application Publication
(10) Pub. No.: US 2008/0099132 A1
(43) Pub. Date: May 1, 2008

(54) Product driven in-line glue dot applicator and method for using same

(75) Inventor: Reid C. Moertl, Germantown, WI (US)

Correspondence Address: REINHART BOERNER VAN DEUREN P.C., 2215 PERRYGREEN WAY, ROCKFORD, IL, 61107, US

(73) Assignee: Glue Dots International, LLC, New Berlin, WI (US)

(21) Appl. No.: 11/588,695

(22) Filed: Oct. 27, 2006

(51) Int. Cl. B32B 37/00

(52) U.S. Cl. 156/238; 156/543

(57) ABSTRACT

A method and apparatus are provided, for transferring pressure-sensitive adhesive segments from a rolled flexible carrier release tape to a workpiece, by directing the flexible carrier release tape to a dispensing member attached to a pivotable arm, and pivoting the arm in such a manner that the dispensing member clamps the flexible carrier release tape against the workpiece. With the carrier release tape clamped against the workpiece, relative linear movement between the carrier release tape and the workpiece is initiated, in such a manner that the relative motion unrolls the flexible carrier tape and moves one or more pressure-sensitive adhesive segments into pressurized contact with the workpiece so that the one or more pressure-sensitive segments are transferred from the flexible carrier tape to the workpiece.

### FIELD OF THE INVENTION

This invention relates generally to pressure sensitive adhesives and their applications to desired surfaces, and more specifically to transferring pressure sensitive adhesive segments from a roll of flexible carrier release tape to a desired surface.

### BACKGROUND OF THE INVENTION

Pressure sensitive adhesives are widely used in a variety of industries. In many applications, it is convenient to apply pressure sensitive adhesive segments to a desired surface of a workpiece from a roll of flexible carrier release tape. The flexible carrier release tape typically has opposed first and second release surfaces which have different release properties. Adhesive segments are arrayed generally longitudinally along the first release surface of the carrier release tape. The second surface of the carrier release tape has a release property different from that of the first surface, so that the adhesive segments do not adhere to the second surface as strongly as they do to the first surface, and so that when the carrier release tape is wound into a roll, the first surface, and the adhesive segments applied thereto will be on the external surface of the roll of segment-laden carrier release tape. As the roll of carrier release tape is wound, therefore, the pressure sensitive adhesive segments will be wound between the first carrier release surface of the portion of the tape to which they are attached, and the second release surface of the successive layer of the roll of flexible carrier tape. Because the pressure sensitive adhesive does not adhere readily to the second release surface of the carrier tape, the tape may be readily unrolled, with the adhesive segments remaining attached to the first surface of the carrier tape, as the carrier tape with the adhesive segments attached to the first surface thereof are fed out for application to a desired surface of the workpiece.

Commonly assigned U.S. Patent Applications 2005/0178507 A1, 2005/0266198 A1, 2003/0118771 A1, and 2003/0116284 A1 describe a variety of apparatuses and methods for transferring pressure sensitive adhesive segments from a roll of flexible carrier release tape to a desired surface of a workpiece, through use of hand-held applicators.

These patent applications disclose and teach the construction and use of generally hand-held applicators, which in various embodiments thereof, feed the flexible carrier release tape with the adhesive segments attached thereto out through a manually or motorized drive mechanism.

Although the methods and apparatuses disclosed and taught by the Assignee's patent applications work well in a wide range of applications, there are circumstances in which it is desirable to have an applicator be mounted and operable in such a manner that it need not be held in the hand of an operator to accomplish application of the pressure sensitive adhesive segments to a workpiece.

Commonly assigned U.S. Patent Application No. 2003/0164220 A1 discloses and teaches the use of a stand and actuating arrangement for supporting a hand-held applicator in such a manner that adhesive segments may be applied to a workpiece by contact between an actuating arm of the actuator and the workpiece.

Although mounting of a hand-held applicator on a support stand, in the manner disclosed and taught by the '220 patent application works well in certain circumstances, there are circumstances in which such an arrangement cannot be effectively and efficiently utilized.

It is desirable, therefore, to provide an improved apparatus and method for transferring pressure-sensitive adhesive segments from a roll of flexible carrier release tape to the surface of a workpiece.

### BRIEF SUMMARY OF THE INVENTION

The invention provides an improved method and apparatus for transferring pressure sensitive adhesive segments from a rolled flexible carrier release tape to a workpiece, by directing the flexible carrier release tape to a dispensing member attached to a pivotable arm, and pivoting the arm in such a manner that the dispensing member clamps the flexible carrier release tape against the workpiece. Relative linear movement between the carrier release tape and the workpiece is then initiated, in such a manner that the relative motion unrolls the flexible carrier tape and moves one or more pressure sensitive adhesive segments into pressurized contact with the workpiece in such a manner that one or more pressure sensitive segments are transferred from the flexible carrier tape to the workpiece.

In some forms of the invention, a position of the flexible carrier is monitored as it is unrolled by the relative motion, and the pivoting arm is controlled in such a manner that the dispensing member unclamps the flexible carrier release tape after a desired length of release tape has been unrolled. In other forms of the invention, a position of the flexible carrier tape is monitored as it is unrolled by the relative motion, and the pivoting arm is controlled in such a manner that the dispensing member unclamps the flexible carrier release tape after a desired number of pressure sensitive adhesive segments have been brought into clamped contact with the workpiece.

In some forms of the invention, relative motion between the pivotable arm and the workpiece is generated by moving the workpiece linearly relative to the pivotable arm. In other forms of the invention, the relative motion is generated by moving the pivotable arm linearly relative to the workpiece.

An apparatus for transferring pressure sensitive adhesive segments from a rolled flexible carrier release tape to a workpiece, according to the invention, may include a pivotable arm, pivotably mounted for selective movement from a first to a second angular position, and a dispensing member attached to the pivotable arm. The dispensing member is operatively connected to the rolled flexible carrier tape in such a manner that when the arm is pivoted to the first angular position, the dispensing member clamps the flexible carrier release tape against the workpiece, such that relative linear motion between the carrier release tape and the workpiece unrolls the flexible carrier tape and moves one or more pressure sensitive adhesive segments into pressurized contact with the workpiece, in such a manner that one or more pressure sensitive segments are transferred from the flexible carrier tape to the workpiece. An apparatus, according to the invention, may further include an instrumentality for generating relative linear motion between the arm and the workpiece. The instrumentality may generate the relative motion by moving the workpiece linearly relative to the pivotable arm. In other forms of an apparatus, the instrumentality may generate the relative motion by moving the pivotable arm linearly relative to the workpiece.

An apparatus, according to the invention, may include a position sensing and control arrangement, for monitoring a position of the flexible carrier as it is unrolled by the relative motion, and for pivoting the arm in such a manner that the dispensing member unclamps the flexible carrier release tape after a desired length of the release tape has been unrolled. In other forms of the invention, a position sensing and control arrangement, according to the invention, may pivot the arm in such a manner that the dispensing member unclamps the flexible carrier release tape after a desired number of pressure sensitive adhesive segments have been brought into clamped contact with the workpiece.

In one form of a pressured sensitive adhesive segment dispensing apparatus, for selectively attaching the pressure-sensitive adhesive segments to a workpiece surface, the dispensing apparatus may include a pivotable arm, an actuator arrangement, a supply spool mounting arrangement, and an adhesive dispensing roller.

The pivotable arm may define first and second ends of the arm, and an arm axis extending between the first and second ends of the arm. The arm may also define a pivot axis disposed between the first and second ends, and extending substantially perpendicular to the arm axis, with the arm being adapted for pivotable movement about the pivot axis.

The actuator arrangement is operatively connected to the arm for causing the arm to pivot about the pivot axis substantially along a plane of arm movement extending orthogonally to the pivot axis, from an apply position of the arm to a retracted position of the arm.

The supply spool mounting arrangement is rotatably attached to the arm for rotation about a supply spool axis extending substantially parallel to the pivot axis of the arm. The supply spool mounting arrangement is adapted for holding a roll of flexible carrier release tape in such a manner that the flexible carrier release tape is oriented to extend along a longitudinal path running substantially parallel to the plane of arm movement. The flexible carrier release tape has a transverse width, opposed first and second release surfaces, and a plurality of pressure-sensitive adhesive segments arrayed non-contiguously in a longitudinally spaced-apart progression along the first release surface of the carrier release tape.

The adhesive dispensing roller is rotatably mounted to the arm proximate the first end of the arm for rotation about a dispensing roll axis extending substantially parallel to the pivot axis. The dispensing roller has a peripheral surface thereof adapted for bearing against the second release surface of the flexible carrier tape, for guiding the flexible carrier tape along a portion of the longitudinally extending path of the tape. The peripheral surface of the dispensing roller is also adapted for applying a clamping force, directed substantially perpendicularly to the longitudinal path through the flexible carrier tape, and/or the pressure-sensitive adhesive segments attached to the carrier tape, in such a manner that the tape may be advanced by relative motion between the arm and the workpiece for positioning the pressure-sensitive adhesive segments between the dispensing roller and the workpiece surface, when the arm is disposed in the apply position.

In some forms of the invention, a dispensing apparatus, according to the invention also includes a take-up spool mounting arrangement, rotatably attached to the arm for rotation about a take-up spool axis extending substantially parallel to the pivot axis of the arm, and adapted for forming and holding a roll of the flexible carrier release tape received along the longitudinal path.

The dispensing apparatus may also include a drive arrangement operatively connecting the supply spool mounting arrangement to the take-up spool mounting arrangement, in such a manner as the flexible carrier tape pulled from the supply reel along the longitudinally directed path, and the supply spool is thereby rotated about the supply spool axis. Rotation of the supply spool mounting arrangement is transferred by the drive arrangement to the take-up spool mounting arrangement for rotating the take-up spool about the take-up spool axis.

In some forms of the invention, the drive arrangement drives the take-up spool at a higher rotational speed than the dispensing spool, in such a manner that tension is continually maintained in the flexible carrier tape along the longitudinal path. In some forms of the invention, the drive arrangement may be a belt and pulley arrangement, having a drive pulley and a driven pulley connected by a drive belt, with the drive pulley being larger then the driven pulley. The drive pulley is operatively attached to the supply spool mounting arrangement, and the smaller pulley is operatively attached to the take-up spool mounting arrangement. The belt is operatively attached between the drive and driven pulleys in such a manner that the belt is capable of a limited amount of slippage over one or both of the drive and driven pulleys, in such a manner that continual tension is maintained along the longitudinal path of the flexible carrier tape, throughout the process of unwinding the flexible carrier tape from the supply spool and winding it onto the take-up spool.

A supply spool drive arrangement, according to the invention, may include first and second supply spool drive arrangement side plates, adapted for operatively clamping the supply spool therebetween, with the second drive spool side plate being selectively removable for installation and removal of the supply spool. The first supply spool drive arrangement side plate may further include an inner surface thereof, adapted for frictionally engaging one of a first or second longitudinally extending edges of the flexible carrier tape, when the supply spool is clamped between the first and second supply spool drive arrangement side plates, to thereby substantially preclude slippage of an outer layer of the roll of flexible carrier tape with respect to an inner layer of the flexible carrier tape, as the tape is pulled from the supply spool along the longitudinally oriented path.

A second supply spool drive plate, according to the invention, may be constructed in a manner allowing the supply spool to be viewed through the second side plate, to thereby allow viewing of the amount of flexible carrier tape remaining on the supply spool. Where the second side plate is fabricated from a substantially opaque material, it may include an opening therein through which the supply spool can be viewed.

An apparatus, according to the invention, may also include a pre-dispensing guide roller, which is rotatably mounted to the arm along the longitudinal path between the supply spool and the adhesive dispensing roller, for rotation about a pre-dispensing roller axis extending substantially parallel to the pivot axis. The pre-dispensing roller includes a peripheral surface thereof, adapted for bearing against the first release surface of the flexible carrier tape, and/or the pressure-sensitive adhesive segments attached to the first release surface, for guiding the flexible carrier tape along a portion of the longitudinally extending path of the tape between the supply spool and the adhesive dispensing roller. The pre-dispensing roller may have a peripheral surface thereof which is resistant to adhesion thereto of the pressure-sensitive adhesive segments. The peripheral surface of the pre-dispensing roller may include grooves or other surface treatments therein, for reducing contact of the peripheral surface of the pre-dispensing roller with the first release surface of the flexible carrier tape, or the pressure-sensitive adhesive segments attached to the first release surface. The peripheral surface of a pre-dispensing roller, according to the invention, may include a material having a low adhesion to the pressure-sensitive adhesive segments attached to the first release surface. The peripheral surface of a pre-dispensing roller including a material having a low adhesion to the pressure-sensitive adhesive segments may also include grooves therein for reducing contact of the peripheral surface of the pre-dispensing roller with the first release surface of the flexible carrier tape or the pressure-sensitive adhesive segments attached to the first release surface.

Some forms of the invention may also include a post-dispensing guide roller rotatably mounted to the arm along the longitudinal path, for receiving the flexible carrier tape from the dispensing roller, and further operatively mounted for rotation about a post-dispensing roller axis extending substantially parallel to the pivot axis. The post-dispensing roller includes a peripheral surface thereof adapted for bearing against the second release surface of the flexible carrier tape, for guiding the flexible carrier tape along a portion of the longitudinally extending path. In forms of the invention including both a pre-dispensing roller, and a post-dispensing roller, the longitudinally extending path may extend sequentially from a lower portion of the supply spool, over the pre-dispensing roller, about a portion of the periphery of the dispensing roller, around a portion of the periphery of the post-dispensing roller, and back over an upper portion of the supply spool, to the take-up spool.

Some forms of the invention may include a position sensor, for monitoring a position of the flexible carrier tape along the longitudinally oriented path. In forms of the invention including a post-dispensing roller, the sensor may be located between the dispensing roller and the post-dispensing roller. A flexible carrier tape, for use in practicing the invention, may include registration indicators detectable by the position sensor. Where the registration indicators are optically detectable, the position sensor may include an optical sensor adapted for detecting the registration indicators.

The invention may further include an arm support member, having the arm pivotably connected thereto along the pivot axis. The actuator arrangement, according to the invention, may be operatively connected between the arm and the arm support member, for pivoting the arm with respect to the arm support member. In some forms of the invention, having an arm support member, the arm support member is stationary and the workpiece is movable linearly relative to the arm support member, for transferring one or more adhesive segments from the flexible carrier tape to the workpiece. In other forms of the invention, the workpiece may be held stationary with the arm support member being movable linearly relative to the workpiece, for transferring one or more adhesive segments from the flexible carrier tape to the workpiece.

Other aspects, objects, and advantages of the invention will be apparent from the following detailed description and accompanying drawings, illustrating exemplary embodiments of the invention.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective illustration, from a first view angle, of an exemplary embodiment of a dispensing apparatus, in accordance with the invention;

FIG. 2 is a perspective illustration, from a second viewing angle, of the exemplary embodiment of the dispensing apparatus shown in FIG. 1;

FIG. 3 is a partially schematic orthographic illustration of a first application of the exemplary dispensing apparatus of FIGS. 1 and 2, wherein, relative linear motion between a pivotable arm of the dispensing apparatus and one or more workpieces is provided by moving the workpieces linearly with respect to the arm of the dispensing apparatus;

FIG. 4 is a partially schematic illustration of an application of the exemplary embodiment of the dispensing apparatus of FIGS. 1 and 2, in an application where relative motion between the arm of the dispensing apparatus and one or more workpieces is generated by holding the workpieces stationary and moving the arm linearly along a linear guide rail arrangement;

FIGS. 5 and 6 are orthographic side views of the exemplary embodiment of the dispensing apparatus of FIGS. 1 and 2, respectively illustrating the dispensing apparatus in a first, or apply, angular position of the arm, and a second, retracted angular position of the arm;

FIG. 7 is a partially cut-away orthographic view of a portion of the exemplary embodiment of the dispensing apparatus of FIGS. 1 and 2, illustrating construction and operational details of the dispensing apparatus;

FIG. 8 is a perspective illustration, from a view angle similar to the view angle of FIG. 1, having some of the components in the foreground removed and others shown in dashed lines, in order to illustrate construction and functional details of a drive arrangement of the exemplary embodiment of the dispensing apparatus of FIGS. 1 and 2;

FIG. 9 is a partially exploded perspective view of a supply spool mounting arrangement of the exemplary embodiment of the dispensing apparatus of FIGS. 1 and 2; and

FIG. 10 is a partially exploded perspective illustration of a take-up spool mounting arrangement of the exemplary embodiment of the dispensing apparatus of FIGS. 1 and 2.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

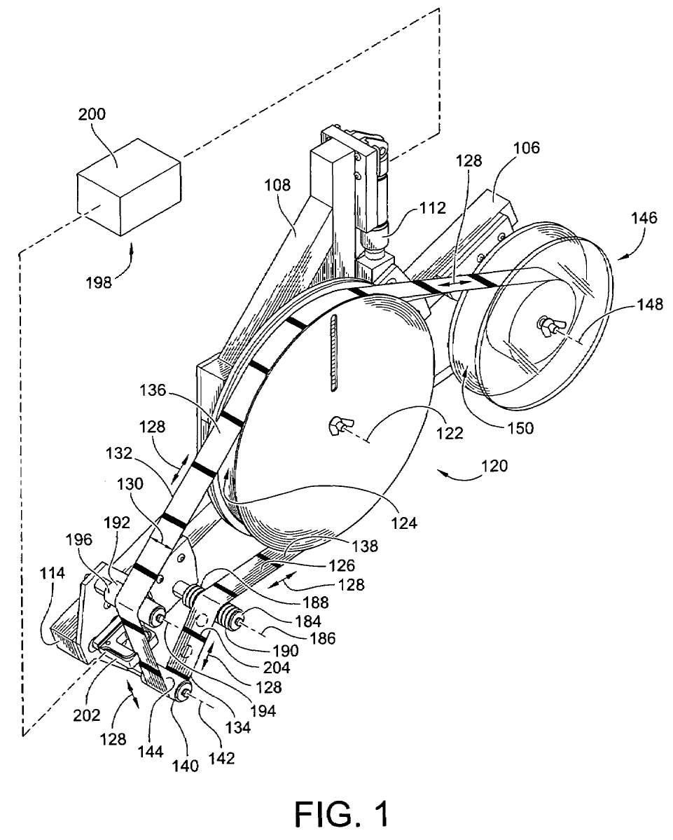

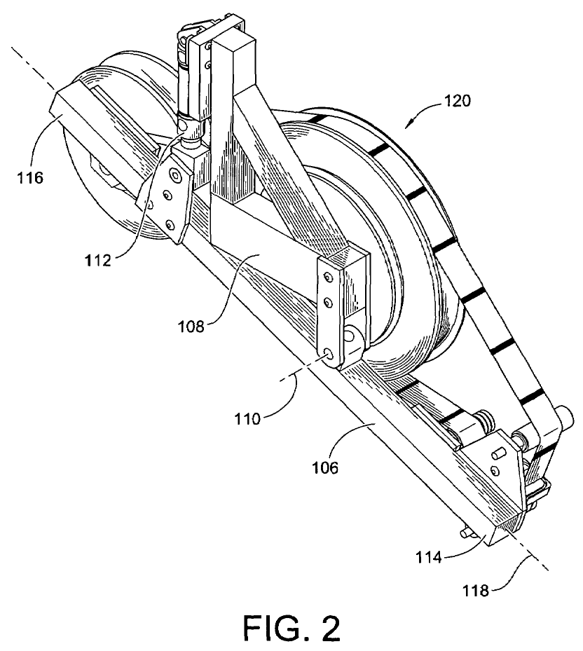

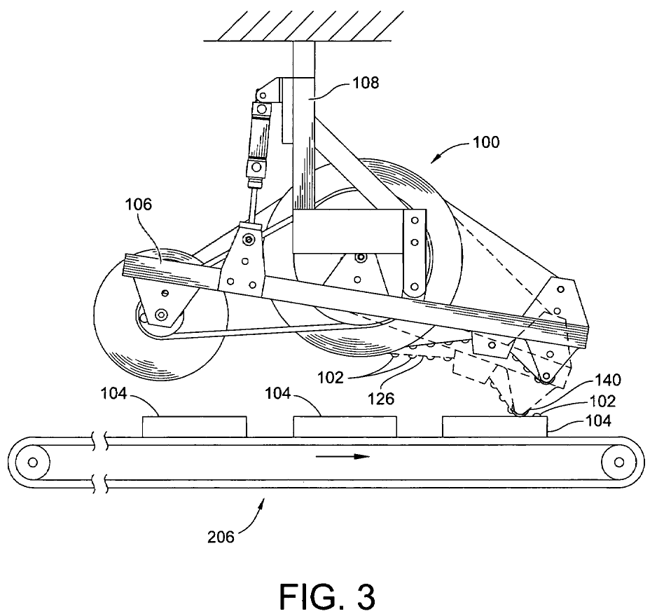

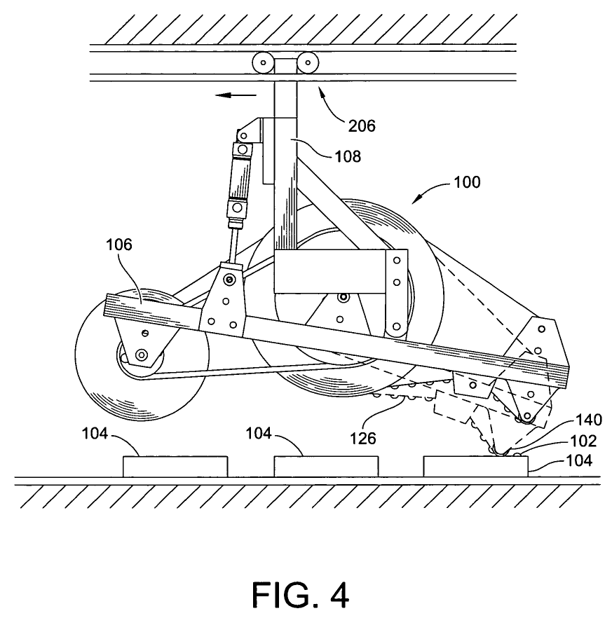

FIGS. 1 and 2 illustrate a first exemplary embodiment of a pressure-sensitive adhesive segment dispensing apparatus 100, according to the invention, for selectively attaching the pressure-adhesive segments 102 to a surface of a workpiece 104, in the manner described in greater detail below, and as illustrated in FIGS. 3 and 4.

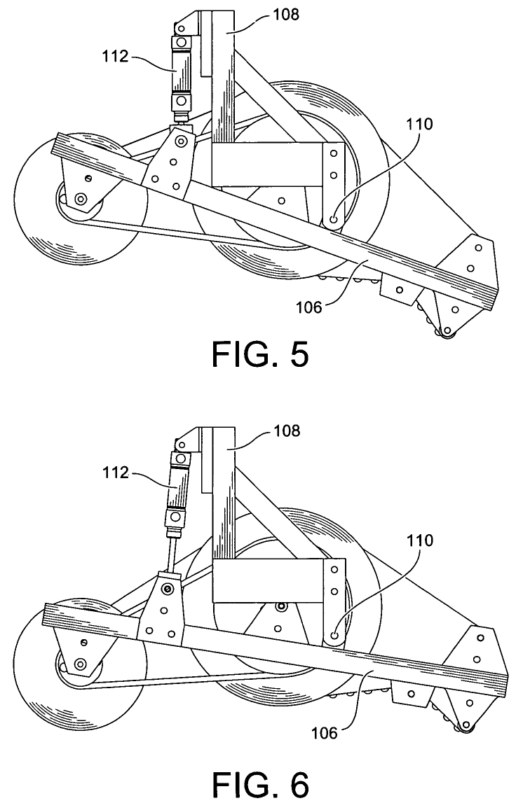

As best seen in FIG. 2, the dispensing apparatus 100 includes an arm 106 pivotably mounted to an arm support member 108 for pivotable movement about an arm pivot axis 110. An actuator arrangement, including a pneumatic cylinder 112 operatively connects the arm 106 to the arm support member 108, in such a manner that the arm 106 may be pivoted about the pivot axis 110 from a first (apply) angular position of the pivot arm 106, as shown in FIG. 5, to a second (retracted) angular position of the pivot arm 106, as shown in FIG. 6. In other embodiments of the invention, other types of actuators, i.e. hydraulic, electric, mechanical, etc., could be used instead of a pneumatic cylinder.

As further illustrated in FIG. 2, the arm 106 has first and second ends 114, 116 thereof, and defines an arm axis 118 extending between the first and second ends 114, 116 of the arm 106. From the description given thus far, and examination of the referenced drawing FIGS., it will be appreciated that the operative arrangement and construction of the arm 106, the arm support member 108, and the actuator arrangement 112 cause the arm 106 to pivot about the pivot axis 110 and travel substantially angularly along a plane of arm movement extending orthogonally to the pivot axis 110, from the apply position shown in FIG. 5, to the retracted position of the arm shown in FIG. 6.

As shown in FIGS. 1, 2, and 7, a supply spool mounting arrangement 120 is rotatably attached to the arm 106, for rotation about a supply spool axis 122, which extends substantially parallel to the pivot axis 110 of the arm 106. The supply spool mounting arrangement 120 is adapted, in a manner to be described in more detail below, for holding a roll 124 of flexible carrier release tape 126 oriented to extend along a longitudinal path, as illustrated by arrows 128, in FIG. 1, with the longitudinal path 128 running substantially parallel to the plane of movement of the arm 106. The flexible carrier release tape 126 has a transverse width 130 extending between first and second longitudinal edges 132, 134 of the carrier tape 126. The flexible carrier tape 126 further includes opposed first and second release surfaces 136, 138, and a plurality of pressure-sensitive adhesive segments 102 arrayed non-contiguously in a longitudinally spaced-apart progression along the first release surface 136 of the carrier release tape 126.

As shown in FIG. 1, an adhesive dispensing roller 140 is rotatably mounted to the arm 106 proximate to the first end 114 of the arm 106, for rotation about a dispensing roller axis 142, which extends substantially parallel to the pivot axis 122.

The dispensing roller 140 has a peripheral surface 144 thereof, adapted for bearing against the second release surface 138 of the flexible carrier tape 126, for guiding the flexible carrier tape along a portion of the longitudinally extending path 128 of the tape 126. The peripheral surface 144 of the dispensing roller 140 is also adapted for applying a clamping force directed substantially perpendicularly to the longitudinal path 128, through the flexible carrier tape 126, and/or the pressure-sensitive adhesive segments 102 attached to the carrier tape 126, such that the tape 126 may be advanced by relative linear motion between the arm 106 and the workpiece 104 for positioning the pressure-sensitive adhesive segments 102 between the dispensing roller 140 and the surface of the workpiece 104, when the arm 106 is disposed in the apply position, as shown in FIG. 5.

As shown in FIG. 1, the exemplary embodiment of the dispensing apparatus 100 further includes a take-up spool mounting arrangement 146, rotatably attached to the arm 106 for rotation about a take-up spool axis 148 extending substantially parallel to the pivot axis 110 of the arm 106. The take-up spool mounting arrangement 146 is adapted for forming and holding a roll 150 of the flexible carrier release tape 126, received along the longitudinal path 128.

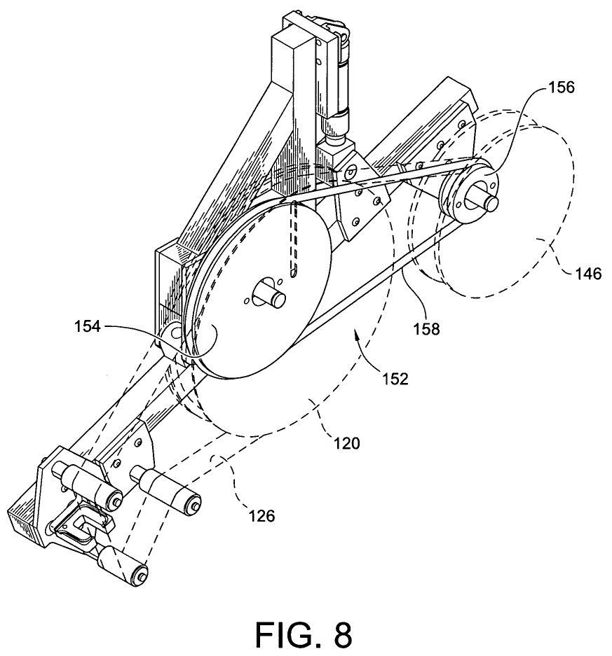

As best seen in FIG. 8, the dispensing apparatus 100 further includes a drive arrangement 152 operatively connecting the supply spool mounting arrangement 120 to the take-up spool mounting arrangement 146, in such a manner that as the flexible carrier tape 126 is pulled from the supply spool, i.e. the roll 124 of carrier tape 126, along the longitudinally directed path 128, thereby resulting in the supply spool 122 being rotated about the supply spool axis 122, rotation of the supply spool mounting arrangement 120 is transmitted by the drive arrangement 152 to the take-up spool mounting arrangement 146, for rotating the take-up spool 150 about the take-up spool axis 148. Specifically, the drive arrangement 152, in the exemplary embodiment, is a belt and pulley arrangement, having a drive pulley 154 and a driven pulley 156 connected by a drive belt 158. The drive pulley 152 is attached to the supply spool mounting arrangement 120, for rotation therewith about the supply spool axis 122, and the driven pulley 154 is connected to the take-up spool mounting arrangement 146, for rotation therewith about the take-up spool axis 148.

As illustrated in FIG. 8, the drive pulley 154 is larger in diameter than the driven pulley 156, in the exemplary embodiment 100, so that the take-up spool mounting arrangement 146 is driven at higher rotational speed than the take-up spool mounting arrangement 146. By virtue of this arrangement, tension is continually maintained on the flexible carrier tape 126, along the longitudinally extending path 128. The drive belt 158, and the drive and driven pulleys 154, 156, are cooperatively configured such that the drive belt 158 is capable of a limited amount of slippage over one or both of the drive or driven pulleys 154, 156, so that tension is continually maintained in the flexible carrier tape 126 as the carrier tape 126 is transferred from the supply spool 124 to the take-up spool 150, to thereby compensate for the change in relative outer diameters of the roll of carrier tape 124 and the roll 124 of carrier tape 126 remaining in the supply spool mounting arrangement 120 and the outer diameter of the roll 150 of the carrier tape 126 being wound up by the take-up spool mounting arrangement 146.

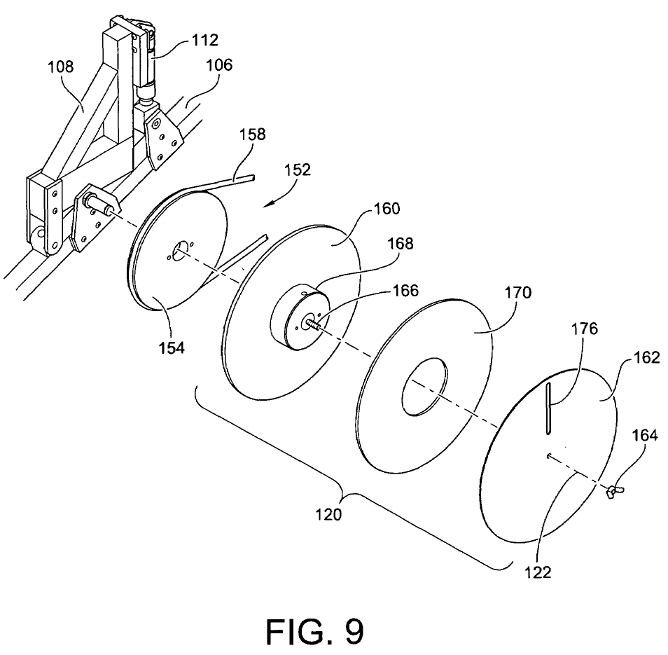

As shown in FIG. 9, the supply spool mounting arrangement 120, of the exemplary embodiment 100 includes first and second supply spool drive arrangement side plates 160, 162 thereof, adapted for operatively clamping a supply spool, in the form of the roll 124 of carrier tape 126 between the first and second side plates 160, 162. The second side plate 162 is removable, by unscrewing a wing nut 164 from a threaded member 166, in the exemplary embodiment, for installation and removal of the roll 124 of carrier tape 126.

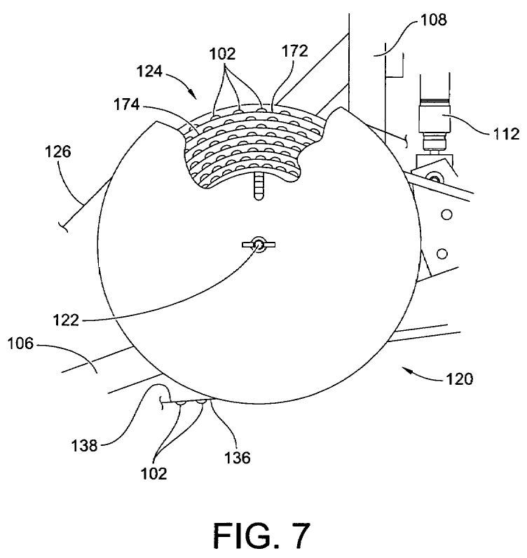

As further illustrated in FIG. 9, a hub 168 protrudes from the first side plate 160, to engage a hollow central core (not shown) upon which the carrier tape 126 is wound to form the roll 124 of carrier tape 126. In the exemplary embodiment, the first supply spool drive arrangement side plate 160 further includes a layer of felt material 170, attached to the first side plate 160 to thereby form a cushioned inner surface of the first side plate 160, which is adapted for frictionally engaging one of the first or second longitudinally extending edges 132, 134 of the flexible carrier tape 126. By virtue of this arrangement, when the roll 124 of carrier tape 126 is clamped between the first and second side plates 160, 162 of the supply spool drive arrangement 120, slippage of an outer layer 172 (see FIG. 7) of the roll 124, with respect to an inner layer 174 of the roll 124 of flexible carrier tape 126, is substantially precluded, as the tape 126 is pulled from the roll 124 along the longitudinally oriented path 128.

The second side plate 162, of the supply spool mounting arrangement 120, in the exemplary embodiment 100, is formed from a relatively strong, opaque material, such as steel. Because the second side plate 162 is opaque, in the exemplary embodiment, an opening, in the form of a slot 176 is provided in the second side plate 162, so that the amount of flexible carrier tape 126 remaining within the supply spool mounting arrangement 120 can be monitored by looking through the slot 176. In other embodiments of the invention, where the second side plate 162 is not fabricated from a material that is completely opaque, other provisions may be utilized in lieu of providing the opening 176, such as having the side plate 162 formed from a transparent material, or having the second side plate 162 include a transparent area.

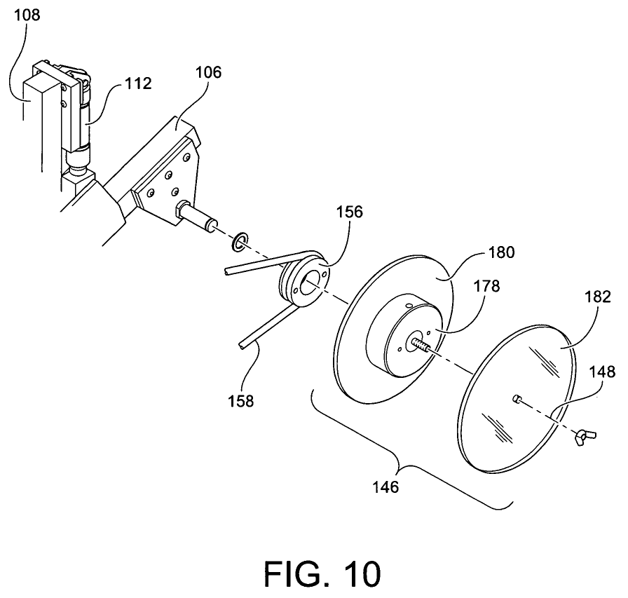

As illustrated in FIG. 10, the take-up spool mounting arrangement 146 is constructed in substantially the same manner as described above, with relation to the supply spool mounting arrangement 120. The take-up spool mounting arrangement 146 includes a hub 178, for receiving thereon a core (not shown), such as a disposal cardboard tube, to which the distal end of the flexible carrier release tape 126 is taped or otherwise affixed, and upon which the carrier tape 126 is wound, during operation of the dispensing apparatus 100. In contrast to the supply spool mounting arrangement 120, however, an additional cushion, such as the layer of felt material 170 of the supply spool mounting arrangement 120, is not provided on the first side plate 180 of the take-up spool mounting arrangement 146, because, once the pressure-sensitive adhesive segments 102 are removed from the carrier tape 126, there is little danger of slippage of an outer layer of the take-up roll 150, with respect to an inner layer of the take-up roll 150, of the nature which might occur in the supply spool 124, and because slippage would actually be advantageous for forming a compact take-up roll. The hub 178 of the take-up spool mounting arrangement 146, in the exemplary embodiment 100 has an outer periphery thereof configured for grasping the core, in combination with the first and second side plates 180, 182 tightly enough that the take-up spool mounting arrangement will be capable of tightly wrapping the flexible carrier release tape 126 onto the disposable core.

As best seen in FIG. 1, the exemplary embodiment of the dispensing apparatus 100 also includes a pre-dispensing guide roller 184 rotatably mounted to the arm 106 along the longitudinal path 128 between the supply spool 124 and the adhesive dispensing roller 140, for rotation about a pre-dispensing roller axis 186 extending substantially parallel to the pivot axis 110. The pre-dispensing roller 184 has a peripheral surface 188 thereof, adapted for bearing against the first release surface 136 of the flexible carrier tape 126, and/or the pressure-sensitive adhesive segments 102 attached to the first release surface 136, for guiding the flexible carrier tape 126 along a portion of the longitudinally extending path 128 of the tape 126 between the supply spool 124 and the adhesive dispensing roller 140. In the exemplary embodiment, the peripheral surface 188 of the pre-dispensing roller 184 is resistant to adhesion thereto of the pressure-sensitive adhesive segments 102. The pre-dispensing guide roller may have a surface, for example, fabricated from a material such as a silicone rubber or another polymer having a low co-efficient of adhesion to the pressure-sensitive adhesive segments 102. In addition, and/or alternatively, the peripheral surface 188 of the pre-dispensing guide roller 184 may have some form of surface treatment, such as a plurality of grooves 190 being formed therein, for reducing contact of the peripheral surface 188 of the pre-dispensing roller 184 with the first release surface 136 of the flexible carrier tape 126 and the pressure-sensitive adhesive segments 102 attached to the first release surface 136.

As shown in FIG. 1, the exemplary embodiment of the dispensing apparatus 100 also includes a post-dispensing guide roller 192, rotatably mounted to the arm 106 along the longitudinal path 128, for receiving the flexible carrier tape 126 from the adhesive dispensing roller 140. The post-dispensing guide roller 192 is mounted for rotation about a post-dispensing roller axis 194 extending substantially parallel to the pivot axis 110. The post-dispensing roller 192 has a peripheral surface 196 thereof, adapted for bearing against the second release surface 138 of the flexible carrier tape 126, for guiding the flexible carrier tape along a portion of the longitudinally extending path 128. After leaving the post-dispensing guide roller 192, the flexible carrier release tape 126 is directed across an upper portion of the supply spool 124 to a point of attachment with the disposable and/or recyclable core inside the take-up spool mounting arrangement 146.

As shown in FIG. 1, the exemplary embodiment of the dispensing apparatus 100 includes a position sensing and control arrangement 198, including a controller 200 operatively connected between a position sensor 202 and the pneumatic cylinder 112, for monitoring a position of the flexible carrier tape 126, as it is unrolled by relative linear motion between the arm 106 and the workpiece 104, and for pivoting the arm 106 in such a manner that the dispensing apparatus 100 clamps at an appropriate point along the workpiece 104 and then unclamps the flexible carrier release tape 126 after a desired number of pressure-sensitive adhesive segments 102 have been brought into clamped contact with the workpiece 104, in a manner described in more detail below.

In the exemplary embodiment 100, the position sensor 202 is an optical sensor, for sensing registration marks 204, in the form of marking bars extending across the transverse width 130 of the carrier tape 126 between adjacent adhesive segments 102, in the exemplary embodiment, in such a manner that, by counting passage and/or monitoring the location of successive registration marks 204, the position sensor 202 and controller 200 can ascertain the number of pressure-sensitive adhesive segments 102 which have been brought into clamped contact with the workpiece 104. The position sensor 202 and controller 200, may also utilize a timer or clock function, or any other appropriate parameter in addition to, or in lieu of optically sensing the registration marks 204, for monitoring and controlling operation of the dispensing apparatus 100.

FIG. 3 illustrates the manner in which the exemplary embodiment of the dispensing apparatus 100 may be utilized for transferring the pressure-sensitive adhesive segments 102 to workpieces 104, in an application where the arm 106 is held stationary, by virtue of attaching the arm support member 108 fixedly to a stationary structure, while the workpieces 104 are moved linearly, relative to the arm 106, by an appropriate arrangement, such as the conveyor 206 illustrated schematically in FIG. 3. As will be understood from examination of FIG. 3, in combination with the description given above, when the workpiece 104 is approaching a desired position for deposition thereupon of one of the adhesive segments 102, the dispensing mechanism is actuated, the arm 106 is pivoted to the position illustrated by dashed lines in FIG. 3, wherein the dispensing roller 140 clamps the carrier tape 126 against the surface of the workpiece 104. As the conveyor 206 continues to move the workpiece 104 in a linear direction relative to the arm 106, clamping force generated by the dispensing roller 140, in conjunction with the relative motion, causes the carrier tape 126 to be pulled from the supply spool 124 to the point that a desired one or more of the pressure-sensitive adhesive segments 102 passes beneath and is clamped between the dispensing roller 140 and the surface of the workpiece 104. The pressure-sensitive adhesive segment 102 bonds with the surface of the workpiece 104 more strongly than with the first release surface 136 of the carrier tape 126, in such a manner that as the relative motion between the workpiece 104 and the arm 106 continues, the pressure-sensitive adhesive segment 102 separates from the carrier tape 126 and remains bonded to the surface of the workpiece 104. If it is desired to transfer only one adhesive segment 102 to the surface of the workpiece 104, the arm 106 is pivoted angularly following deposition of the single adhesive segment 102 to thereby unclamp the carrier tape 126. If it is desired to transfer multiple pressure-sensitive adhesive segments 102, the arm 106 is simply left in the apply position for a longer period of time, so that successive adhesive segments sequentially pass beneath and are clamped between the dispensing roller 140 and the surface of the workpiece 104.

FIG. 4 illustrates operation of the exemplary embodiment of the dispensing apparatus 100 in an installation where the workpieces 104 are resting on a stationary support surface, and the relative motion between the arm 106 and the surface of the workpieces 104 is generated by attaching the arm support member 108 to a linear guide rail apparatus 208, as schematically illustrated in FIG. 4. Operation of the dispensing apparatus 100, in the application illustrated in FIG. 4, is substantially the same as described above in relation to the application of FIG. 3, with the exception that the angular position of the arm 106 is controlled in relation to a linear position of the dispensing apparatus 100 along the guide rail 208, rather than in relation to a linear position of a workpiece on the conveyor 206 of the arrangement shown in FIG. 3.

It is contemplated, that in other embodiments of the invention, other types of conveyance arrangements may be utilized for generating the relative motion between the arm 106 and the workpiece 104. For example, in other embodiments of the invention, a dispensing apparatus, according to the invention, may be attached to some form of moveable boom of a numerically controllable machine or mechanism.

From the foregoing description of exemplary embodiments, together with the referenced drawing figures, those having skill in the art will recognize that the exemplary embodiments described herein provide an improved method and apparatus for transferring pressure-sensitive adhesive segments from a rolled flexible carrier release tape to a workpiece, by first, directing the flexible carrier tape to a dispensing member attached to a pivotable arm, and pivoting the arm in such a manner that the dispensing member clamps the flexible carrier release tape against the workpiece, and then initiating relative linear motion between the carrier release tape and the workpiece, whereby the relative motion unrolls the flexible carrier tape and moves one or more pressure-sensitive adhesive segments into pressurized contact with the workpiece in such a manner that one or more pressure-sensitive segments are transferred from the flexible carrier tape to the workpiece.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A pressure-sensitive adhesive segment dispensing apparatus, for selectively attaching the pressure-sensitive adhesive segments to a workpiece surface, the dispensing apparatus comprising:
a pivotable arm, defining first and second ends of the arm and an arm axis extending between the first and second ends of the arm, the arm also defining a pivot axis disposed between the first and second ends and extending substantially perpendicular to the arm axis, the arm being adapted for pivotable movement about the pivot axis;
an actuator arrangement operatively connected to the arm for causing the arm to pivot about the pivot axis substantially along a plane of arm movement extending orthogonally to the pivot axis, from an apply position of the arm to a retracted position of the arm;
a supply spool mounting arrangement, rotatably attached to the arm for rotation about a supply spool axis extending substantially parallel to the pivot axis of the arm, and adapted for holding a roll of flexible carrier release tape oriented to extend along a longitudinal path running substantially parallel to the plane of arm movement, with the flexible carrier release tape having a transverse width, opposed first and second release surfaces and a plurality of pressure-sensitive adhesive segments arrayed non-contiguously in a longitudinally spaced-apart progression along the first release surface of the carrier release tape; and
an adhesive dispensing roller rotatably mounted to the arm proximate the first end of the arm for rotation about a dispensing roller axis extending substantially parallel to the pivot axis;
the dispensing roller having a peripheral surface thereof adapted for bearing against the second release surface of the flexible carrier tape for guiding the flexible carrier tape along a portion of the longitudinally extending path of the tape;
the peripheral surface of the dispensing roller also being adapted for applying a clamping force directed substantially perpendicularly to the longitudinal path though the flexible carrier tape, and/or the pressure-sensitive adhesive segments attached to the carrier tape, such that the tape may be advanced by relative linear motion between the arm and workpiece for positioning the pressure-sensitive adhesive segments between the dispensing roller and the workpiece surface, when the arm is disposed in the apply position.

2. The dispensing apparatus of claim 1, further comprising a take-up spool mounting arrangement, rotatably attached to the arm for rotation about a take-up spool axis extending substantially parallel to the pivot axis of the arm, and adapted for forming and holding a roll of the flexible carrier release tape received along the longitudinal path.

3. The dispensing apparatus of claim 2, further comprising a pre-dispensing roller and a post-dispensing roller, wherein, the longitudinal path extends sequentially from a lower portion of the supply spool, over the pre-dispensing roller, around a portion or the periphery of the dispensing roller, around a portion of the periphery of the post-dispensing roller, and back over an upper portion of the supply spool, to the take-up spool.

4. The dispensing apparatus of claim 2, further comprising a drive arrangement operatively connecting the supply spool mounting arrangement to the take-up spool mounting arrangement in such a manner that as the flexible carrier tape is pulled from the supply spool along the longitudinally directed path, and the supply spool is thereby rotated about the supply spool axis, rotation of the supply spool mounting arrangement is transmitted by the drive arrangement to the take-up spool mounting arrangement for rotating the take-up spool about the take-up spool axis.

5. The dispensing apparatus of claim 4, wherein, the drive arrangement drives the take-up spool mounting arrangement at a higher rotational speed than the supply spool mounting arrangement.

6. The dispensing apparatus of claim 5, wherein the drive arrangement is a belt and pulley arrangement having a drive pulley and driven pulley connected by a drive belt, with the drive pulley being larger than the driven pulley, the drive pulley being operatively attached to the supply spool mounting arrangement and the smaller pulley being operatively attached to the take-up spool mounting arrangement, and the belt being capable of a limited amount of slippage over one or both of the drive and driven pulleys.

7. The dispensing apparatus of claim 1, wherein, the supply spool drive arrangement includes first and second supply spool drive arrangement side plates thereof, adapted for operatively clamping the supply spool therebetween, with the second drive spool side plate being selectively removable, for installation and removal of the supply spool.

8. The dispensing apparatus of claim 7, wherein:
the flexible carrier tape includes first and second longitudinally extending edges thereof spaced apart by the transverse width; and
the first supply spool drive arrangement side plate further comprises an inner surface thereof adapted for frictionally engaging one of the first and second longitudinally extending edges of the flexible carrier tape, when the supply spool is clamped between the first and second supply spool drive arrangement side plates, to thereby substantially preclude slippage of an outer layer of the roll of flexible carrier tape with respect to an inner layer of the flexible carrier tape as the tape is pulled from the supply spool along the longitudinally oriented path.

9. The dispensing apparatus of claim 7, wherein, the second supply spool drive plate is constructed in a manner allowing the supply spool to be viewed through the second side plate, to thereby allow viewing of the amount of flexible carrier tape remaining on the supply spool.

10. The dispensing apparatus of claim 9, wherein the second side plate is fabricated from a substantially opaque material having an opening therein through which the supply spool can be viewed.

11. The dispensing apparatus of claim 1, further comprising:
a pre-dispensing guide roller rotatably mounted to the arm along the longitudinal path between the supply spool and the adhesive dispensing roller for rotation about a pre-dispensing roller axis extending substantially parallel to the pivot axis;
the pre-dispensing roller having a peripheral surface thereof adapted for bearing against the first release surface of the flexible carrier tape or the pressure-sensitive adhesive segments attached to the first release surface for guiding the flexible carrier tape along a portion of the longitudinally extending path of the tape between the supply spool and the adhesive dispensing roller.

12. The dispensing apparatus of claim 11, wherein, the peripheral surface of the pre-dispensing roller has a resistant to adhesion thereto of the pressure-sensitive adhesive segments.

13. The dispensing apparatus of claim 12, wherein, the peripheral surface of the pre-dispensing roller includes grooves therein, for reducing contact of the peripheral surface of the pre-dispensing roller with the first release surface of the flexible carrier tape or the pressure-sensitive adhesive segments attached to the first release surface.

14. The dispensing apparatus of claim 12, wherein, the peripheral surface of the pre-dispensing roller comprises a material having low adhesion to the pressure-sensitive adhesive segments attached to the first release surface.

15. The dispensing apparatus of claim 14, wherein, the peripheral surface of the pre-dispensing roller includes grooves therein, for reducing contact of the peripheral surface of the pre-dispensing roller with the first release surface of the flexible carrier tape or the pressure-sensitive adhesive segments attached to the first release surface.

16. The dispensing apparatus of claim 1, further comprising:
a post-dispensing guide roller rotatably mounted to the arm along the longitudinal path, for receiving the flexible carrier tape from the adhesive dispensing roller, and for rotation about a post-dispensing roller axis extending substantially parallel to the pivot axis;
the post-dispensing roller having a peripheral surface thereof adapted for bearing against the second release surface of the flexible carrier tape for guiding the flexible carrier tape along a portion of the longitudinally extending path.

17. The dispensing apparatus of claim 1, further including a position sensor, for monitoring a position of the flexible carrier tape along the longitudinally oriented path.

18. The dispensing apparatus of claim 17, wherein, the sensor is located between dispensing roller and the post-dispensing roller.

19. The dispensing apparatus of claim 17, wherein, the flexible carrier tape further comprises registration indicators detectable by the position sensor.

20. The dispensing apparatus of claim 18, wherein, the registration indicators are optically detectable, and the position sensor comprises an optical sensor adapted for detecting the registration indicators.

21. The dispensing apparatus of claim 1, further comprising an arm support member, having the arm pivotably connected thereto along the pivot axis.

22. The dispensing apparatus of claim 20, wherein, the actuator arrangement is operatively connected between the arm and the arm support member, for pivoting the arm with respect to the arm support member.

23. The dispensing apparatus of claim 21, wherein, the arm support member is stationary and the workpiece is movable linearly relative to the arm support member for transferring one or more adhesive segments from the flexible carrier tape to the workpiece.

24. The dispensing arrangement of claim 21, wherein the workpiece is stationary, and the arm support member is movable linearly relative to the workpiece for transferring one or more adhesive segments from the flexible carrier tape to the workpiece.

25. A method for transferring pressure sensitive adhesive segments from a rolled flexible carrier release tape to a workpiece, the method comprising:
directing the flexible carrier tape to a dispensing member attached to a pivotable arm, and pivoting the arm in such a manner that the dispensing member clamps the flexible carrier release tape against the workpiece; and
initiating relative linear motion between the carrier release tape and the workpiece, whereby the relative motion unrolls the flexible carrier tape and moves one or more pressure sensitive adhesive segments into pressurized contact with the workpiece in such a manner that the one or more pressure-sensitive segments are transferred from the flexible carrier tape to the workpiece.

26. The method of claim 24, further comprising, monitoring a position of the flexible carrier as it is unrolled by the relative motion, and pivoting the arm in such a manner that the dispensing member unclamps the flexible carrier release tape after a desired length of the release tape has been unrolled.

27. The method of claim 24, further comprising, monitoring a position of the flexible carrier as it is unrolled by the relative motion, and pivoting the arm in such a manner that the dispensing member unclamps the flexible carrier release tape after a desired number of pressure sensitive adhesive segments have been brought into clamped contact with the workpiece.

28. The method of claim 24, wherein, the relative motion is generated by moving the workpiece linearly relative to the pivotable arm.

29. The method of claim 24, wherein, the relative motion is generated by moving the pivotable arm linearly relative to the workpiece.

30. An apparatus for transferring pressure sensitive adhesive segments from a rolled flexible carrier release tape to a workpiece, the apparatus comprising:
a pivotable arm, pivotably mounted for selective movement from a first to a second angular position; and
a dispensing member attached to the pivotable arm;
the dispensing member also being operatively connected to the rolled flexible carrier tape in such a manner that when the arm is pivoted to the first angular position the dispensing member clamps the flexible carrier release tape against the workpiece, such that relative linear motion between the carrier release tape and the workpiece unrolls the flexible carrier tape and moves one or more pressure sensitive adhesive segments into pressurized contact with the workpiece in such a manner that the one or more pressure sensitive segments are transferred from the flexible carrier tape to the workpiece.

31. The apparatus of claim 29, further comprising, an instrumentality for generating relative linear motion between the arm and the workpiece.

32. The apparatus of claim 30, wherein, the instrumentality generates the relative motion by moving the workpiece linearly relative to the pivotable arm.

33. The apparatus of claim 30, wherein, the instrumentality generates the relative motion by moving the pivotable arm linearly relative to the workpiece.

34. The apparatus of claim 29, further comprising, a position sensing and control arrangement for monitoring a position of the flexible carrier tape as it is unrolled by the relative motion, and pivoting the arm in such a manner that the dispensing member unclamps the flexible carrier release tape after a desired length of the release tape has been unrolled.

35. The apparatus of claim 29, further comprising, a position sensing and control arrangement for monitoring a position of the flexible carrier as it is unrolled by the relative motion, and pivoting the arm in such a manner that the dispensing member unclamps the flexible carrier release tape after a desired number of pressure sensitive adhesive segments have been brought into clamped contact with the workpiece.

36. A pressure-sensitive adhesive segment dispensing apparatus, for selectively attaching the pressure-sensitive adhesive segments to a workpiece surface, the dispensing apparatus comprising:
a pivotable arm, defining first and second ends of the arm and an arm axis extending between the first and second ends of the arm, the arm also defining a pivot axis disposed between the first and second ends and extending substantially perpendicular to the arm axis, the arm being adapted for pivotable movement about the pivot axis;
an actuator arrangement operatively connected to the arm for causing the arm to pivot about the pivot axis substantially along a plane of arm movement extending orthogonally to the pivot axis, from an apply position of the arm to a retracted position of the arm;
a supply spool mounting arrangement, rotatably attached to the arm for rotation about a supply spool axis extending substantially parallel to the pivot axis of the arm, and adapted for holding a roll of flexible carrier release tape oriented to extend along a longitudinal path running substantially parallel to the plane of arm movement, with the flexible carrier release tape having a transverse width, opposed first and second release surfaces and a plurality of pressure-sensitive adhesive segments arrayed non-contiguously in a longitudinally spaced-apart progression along the first release surface of the carrier release tape;
an adhesive dispensing roller rotatably mounted to the arm proximate the first end of the arm for rotation about a dispensing roller axis extending substantially parallel to the pivot axis;
the dispensing roller having a peripheral surface thereof adapted for bearing against the second release surface of the flexible carrier tape for guiding the flexible carrier tape along a portion of the longitudinally extending path of the tape;
the peripheral surface of the dispensing roller also being adapted for applying a clamping force directed substantially perpendicularly to the longitudinal path though the flexible carrier tape, and/or the pressure-sensitive adhesive segments attached to the carrier tape, such that the tape may be advanced by relative linear motion between the arm and workpiece for positioning the pressure-sensitive adhesive segments between the dispensing roller and the workpiece surface, when the arm is disposed in the apply position;
a take-up spool mounting arrangement, rotatably attached to the arm for rotation about a take-up spool axis extending substantially parallel to the pivot axis of the arm, and adapted for forming and holding a roll of the flexible carrier release tape received along the longitudinal path;
a drive arrangement operatively connecting the supply spool mounting arrangement to the take-up spool mounting arrangement in such a manner that as the flexible carrier tape is pulled from the supply spool along the longitudinally directed path, and the supply spool is thereby rotated about the supply spool axis, rotation of the supply spool mounting arrangement is transmitted by the drive arrangement to the take-up spool mounting arrangement for rotating the take-up spool about the take-up spool axis;
the drive arrangement being configured for driving the take-up spool mounting arrangement at a higher rotational speed than the supply spool mounting arrangement;
the drive arrangement including a belt and pulley arrangement having a drive pulley and driven pulley connected by a drive belt, with the drive pulley being larger than the driven pulley, the drive pulley being operatively attached to the supply spool mounting arrangement and the smaller pulley being operatively attached to the take-up spool mounting arrangement, and the belt being capable of a limited amount of slippage over one or both of the drive and driven pulley;
a pre-dispensing guide roller rotatably mounted to the arm along the longitudinal path between the supply spool and the adhesive dispensing roller for rotation about a pre-dispensing roller axis extending substantially parallel to the pivot axis;
the pre-dispensing roller having a peripheral surface thereof adapted for bearing against the first release surface of the flexible carrier tape or the pressure-sensitive adhesive segments attached to the first release surface for guiding the flexible carrier tape along a portion of the longitudinally extending path of the tape between the supply spool and the adhesive dispensing roller;
the peripheral surface of the pre-dispensing roller including a material that is resistant to adhesion thereto of the pressure-sensitive adhesive segment;
the peripheral surface of the pre-dispensing roller includes grooves therein, for reducing contact of the peripheral surface of the pre-dispensing roller with the first release surface of the flexible carrier tape or the pressure-sensitive adhesive segments attached to the first release surface; and
a post-dispensing guide roller rotatably mounted to the arm along the longitudinal path, for receiving the flexible carrier tape from the adhesive dispensing roller, and for rotation about a post-dispensing roller axis extending substantially parallel to the pivot axis;
the post-dispensing roller having a peripheral surface thereof adapted for bearing against the second release surface of the flexible carrier tape for guiding the flexible carrier tape along a portion of the longitudinally extending path;
the longitudinal path extending sequentially from a lower portion of the supply spool, over the pre-dispensing roller, around a portion or the periphery of the dispensing roller, around a portion of the periphery of the post-dispensing roller, and back over an upper portion of the supply spool, to the take-up spool.

37. The apparatus of claim 36, further comprising, a position sensing and control arrangement for monitoring a position of the flexible carrier tape as it is unrolled by the relative motion, and pivoting the arm in such a manner that the dispensing member unclamps the flexible carrier release tape after a desired length of the release tape has been unrolled.

38. The apparatus of claim 36, further comprising, a position sensing and control arrangement for monitoring a position of the flexible carrier as it is unrolled by the relative motion, and pivoting the arm in such a manner that the dispensing member unclamps the flexible carrier release tape after a desired number of pressure sensitive adhesive segments have been brought into clamped contact with the workpiece.

39. The dispensing apparatus of claim 36, further comprising an arm support member, having the arm pivotably connected thereto along the pivot axis, with the actuator arrangement being operatively connected between the arm and the arm support member, for pivoting the arm with respect to the arm support member.

40. The dispensing apparatus of claim 36, wherein:
the supply spool drive arrangement includes first and second supply spool drive arrangement side plates thereof, adapted for operatively clamping the supply spool therebetween, with the second drive spool side plate being selectively removable, for installation and removal of the supply spool;
the flexible carrier tape includes first and second longitudinally extending edges thereof spaced apart by the transverse width; and
the first supply spool drive arrangement side plate further comprises a cushioned inner surface thereof adapted for frictionally engaging one of the first and second longitudinally extending edges of the flexible carrier tape, when the supply spool is clamped between the first and second supply spool drive arrangement side plates, to thereby substantially preclude slippage of an outer layer of the roll of flexible carrier tape with respect to an inner layer of the flexible carrier tape as the tape is pulled from the supply spool along the longitudinally oriented path.
